(19) United States
(12) Patent Application Publication
(10) Pub. No.: US 2024/0308471 A1
(43) Pub. Date: Sep. 19, 2024

(54) Wiper Blade Assembly

(71) Applicant: Illinois Tool Works Inc., Glenview, IL (US)

(72) Inventor: Martin William Rosas, Cypress, TX (US)

(21) Appl. No.: 18/589,853

(22) Filed: Feb. 28, 2024

Related U.S. Application Data
(60) Provisional application No. 63/452,510, filed on Mar. 16, 2023.

(51) Int. Cl. B60S 1/38

(52) U.S. Cl. CPC B60S 1/38; B60S 2001/3812; B60S 2001/3898

(57) ABSTRACT

Described is a wiper blade for a windshield of a vehicle. The wiper blade having a frame structure, a squeegee having a wiping lip, and a plurality of branches extending between the frame structure and the squeegee. The plurality of branches serve to manage compression and tension loads between the frame structure and the squeegee.

### RELATED APPLICATION

The present application claims priority to U.S. Provisional Patent Application No. 63/452,510, filed Mar. 16, 2023, and entitled “Wiper Blade Assembly” which is hereby incorporated by reference in its entirety.

### BACKGROUND

Windshield wipers are used to remove rain, snow, ice, washer fluid, water, and/or other debris from a vehicle's front or rear windshield. Almost all vehicles are equipped with one or more windshield wipers, including cars, trucks, buses, train locomotives, watercraft (e.g., those with a cabin) and even some aircraft. In many jurisdictions, windshield wipers are a legal requirement.

Vehicles use a variety of wiper blade types and configurations, but a common objective for all wiper blade types is that they conform to the surface and/or contour of the glass upon which they are mounted (whether a front or rear windshield). That is, many vehicles use a curved glass, which cannot be wiped effectively with a rigid, linear wiper blade. To address this, a common type of wiper blade incorporates a metal framework that serves as a mount for the actual wiper, which can be a metal-backed strip of, for example, rubber or halogen-hardened rubber. The metal framework is shaped and/or includes spring arms to bias portions of the wiper to ensure contact is maintained between the wiper and the windshield during operation.

Despite advancements to date, a need exists for wiper blade that better conforms to the shape and/or contour of a windshield.

### SUMMARY

The present disclosure relates generally to an improved wiper blade, substantially as illustrated by and described in connection with at least one of the figures, as set forth more completely in the claims. More specifically, the present disclosure relates to a wiper blade that better conforms to the shape and/or contour of a windshield.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an example vehicle having a windshield and a pair of wiper blades.

FIG. 1b illustrates an assembly view of an example connection point between the wiper blade and the wiper arm.

FIG. 2 illustrates a perspective view of a wiper blade accordance with an aspect of the present disclosure.

FIG. 3 illustrates a perspective view of a wiper blade in accordance with another aspect of the present disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Wiper blades used in vehicles vary in size and shape. In some cases, wiper blades can be the same shape, but will vary in size. While wiper blades are most often associated with automobiles (e.g., cars, trucks, etc.), they are likewise employed in numerous other vehicles, such as trains, watercraft, and aircraft. Therefore, the following disclosure should not be limited to wiper blades and wiper arms used in automobiles, but rather would be applicable to wiper blades and wiper arms used in any type of vehicle.

The present disclosure relates to a windshield wiper blade that can be fabricated from a single material using a structural topology optimization.

In one example, a wiper blade comprises a frame structure, a squeegee having a wiping lip, and a plurality of branches extending between the frame structure and the squeegee. The plurality of branches is configured to manage compression and tension loads between the frame structure and the squeegee. In some examples, the plurality of branches vary in thickness to conform the wiping lip to a windshield. For example, the plurality of branches can comprise a plurality of inter-connected members coupled between the frame structure and the squeegee and one or more cross-connected member coupled between two or more adjacent inter-connected members. In an unloaded condition, the frame structure is curved and the squeegee is linear.

In some examples, the frame structure and the squeegee are an integrated component, but in another example, the frame structure, the squeegee, and the plurality of branches is an integrated component. In some examples, the plurality of branches can be configured as a removable insert. The plurality of branches can be arranged to form a truss structure, a bird's nest, and/or a woven pattern. In some examples, the plurality of branches is fabricated via an additive manufacturing technique. For example, the plurality of branches can be fabricated using one or more of thermoplastic polyurethane (TPU), thermoplastic vulcanizates (TPV), thermoplastic elastomers (TPE), and silicon.

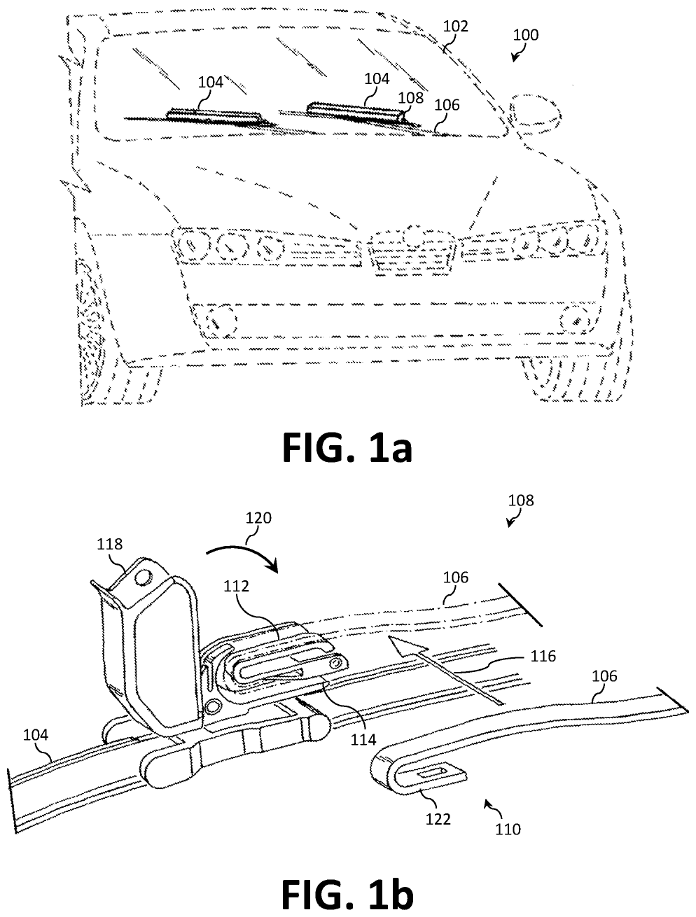

FIG. 1a illustrates an example vehicle 100 having a windshield 102 and a pair of wiper blades 104. As illustrated, each wiper blade 104 is removably coupled to a wiper arm 106 of the vehicle 100 via a coupling 108. As is known in the art, the wiper arms 106 (and, therefore, the wiper blades 104) are configured to translate back and forth across the windshield 102 to clear the windshield 102 of rain, snow, and debris via one or more electric motors and mechanical linkages associated with the vehicle 100.

FIG. 1b illustrates an assembly view of an example coupling 108 between the wiper blade 104 and the wiper arm 106. As illustrated, each wiper arm 106 includes or otherwise defines, at its distal end, an arm-side connector 110. The arm-side connector 110 is configured to engage and secure the wiper blade 104 via a complimentary blade-side connector 112 positioned on or otherwise associated with the wiper blade 104. In the illustrated example, the arm-side connector 110 is inserted into a J-shaped slot 114 of the blade-side connector 112 as indicated by arrow 116. Once assembled, a locking cap 118 can be folded as indicated by arrow 120 (e.g., pivoted about a hinge) and positioned to cover, secure, and protect the connected arm-side connector 110 and blade-side connector 112. In the illustrated example, the wiper arm 106 includes an arm-side connector 110 configured a J-Hook connector 122, but other connector types are contemplated.

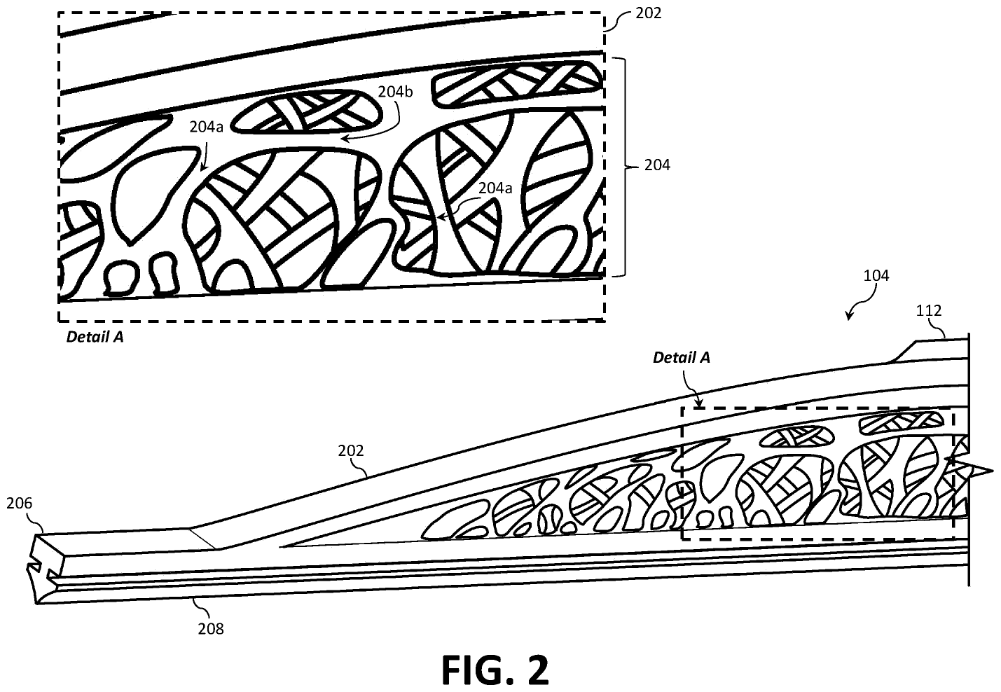

FIG. 2 illustrates a perspective view of a wiper blade 104 in accordance with an aspect of the present disclosure. The wiper blade 104 generally comprises a frame structure 202, a plurality of branches 204, and a squeegee 206 having a wiping lip 208. The plurality of branches 204 extend between the frame structure 202 and the squeegee 206. In one example, the windshield wiper blade 104 and components thereof (e.g., the frame structure 202, the plurality of branches 204, and/or the squeegee 206) can be fabricated from one or more elastomeric materials. Example elastomeric materials include, for example, thermoplastic polyurethane (TPU), thermoplastic vulcanizates (TPV), thermoplastic elastomers (TPE), flexible polyurethane (FPU), silicon, etc. The frame structure 202 is configured to couple to the wiper arm 106 via the blade-side connector 112 of the coupling 108. The blade-side connector 112 may be integral with the frame structure 202 or attached thereto via one or more fasteners, adhesives, etc.

In some examples, two or more components of the windshield wiper blade 104 can be formed from the same material and/or as a single, integrated component. In the illustrated example, the frame structure 202 and squeegee 206 are formed as a single component; however, it is contemplated that the frame structure 202 and squeegee 206 can be fabricated as separate components and then coupled together (e.g., via one or more fasteners, adhesives, etc.). Likewise, it is contemplated that the frame structure 202, the plurality of branches 204, and the squeegee 206 can be formed from the same material and/or as a single, integrated component. Therefore, the windshield wiper blade 104 and components thereof may be formed as a unitary structure.

In some examples, the frame structure 202, the plurality of branches 204, and the squeegee 206 may be a printed plastic material component (e.g., thermoplastic, TPU, FPU, etc.). Printed plastic material components can be printed with great accuracy and with numerous details, which is particularly advantageous, for example, in creating components requiring complex and/or precise features, such as the plurality of branches 204. In addition, additive manufacturing techniques obviate the need for mold tooling, thereby lowering up-front manufacturing costs, which is particularly advantageous in low-volume productions. In some examples, the windshield wiper blade 104 may be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be).

A printing process in a higher vertical resolution printing, however, will take longer to produce finer layers as the printer has to produce more layers. In some examples, therefore, one or more portions of the wiper blade 104 may be formed or otherwise fabricated at different resolutions during a printing operation. For example, the plurality of branches 204 portion may be printed at a higher resolution than that of the frame structure 202 and the squeegee 206 (or vice versa) as needed for a particular application.

As illustrated in FIG. 2, the squeegee 206 is substantially linear when in an unloaded condition; however, when the squeegee 206 is in a loaded condition (i.e., when the wiper blade 104 is installed and positioned against the windshield 102), the squeegee 206 flexes to conform to the curvature of the windshield 102. The specific loading, however, will vary depending on the wiper arm force of the vehicle 100, the specific windshield curvature of the windshield 102, and the plurality and design of branches.

As illustrated, the plurality of branches 204 may be of varying thicknesses and oriented in different directions to manage compression and tension loads between the frame structure 202 and squeegee 206. In some examples, the plurality of branches 204 is arranged to form a truss structure, a bird's nest, or a woven pattern. For example, in the illustrated example, the plurality of branches 204 generally comprises a plurality of inter-connected members 204a coupled between the frame structure 202 and the squeegee 206 and one or more cross-connected member 204b coupled between two or more adjacent inter-connected members 204a. The plurality of inter-connected members 204a can be perpendicular or diagonal relative to the squeegee 206.

The plurality of branches 204 can vary in thickness and can be designed to deform under specific loading. The size and distribution of the plurality of branches 204 can therefore be adjusted to provide a desired pressure distribution curve. Such a controlled deformation allows the frame structure 202 to support the squeegee 206 and ensure the wiping lip 208 conforms to the windshield 102 properly. For example, additional and/or larger branches 204 can be positioned at areas along the squeegee 206 where addition rigidity/pressure from the wiping lip 208 is desired upon the windshield 102. The wiping lip 208 can be a rubber-elastic wiper strip that is located substantially longitudinally axially parallel on said squeegee 206. In some examples, the squeegee 206 (e.g., the wiping lip 208) and/or the plurality of branches 204 can be include or more coatings, such as a hydrophobic and/or non-stick coating.

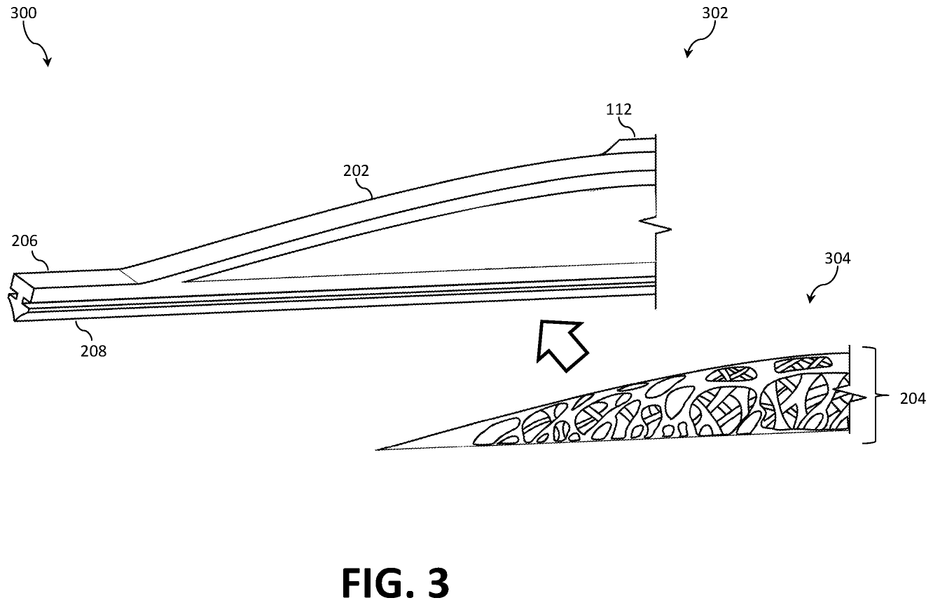

FIG. 3 illustrates a perspective view of a wiper blade 300 in accordance with another aspect of the present disclosure. As illustrated, the wiper blade 300 can be a multiple piece structure having a frame assembly 302 and a removable insert 304. The frame assembly 302 generally comprises or defines the frame structure 202, the squeegee 206, and the blade-side connector 112, while the removable insert 304 generally comprises or defines the plurality of branches 204. Therefore, the plurality of branches 204 can be fabricated and/or provided as a separate, removable insert 304.

Providing the plurality of branches 204 as a removable insert 304 can offer certain benefits. For example, because the shape and/or contour of a windshield 102 is not standardized, a single frame assembly 302 component can be sold where the consumer can select the removable insert 304 (or reuse a removable insert 304) that provides a pressure distribution curve that is most effective for a given windshield 102. The frame assembly 302 and the removable insert 304 can be then joined together by the consumer using, for example, one or more snaps, clips, or other fittings. In some examples, the single frame assembly 302 component can be sold alone and the consumer can purchase and/or download a computer-aided design (CAD) file associated with a removable insert 304 that provides a pressure distribution curve that is most effective for a given windshield 102. The consumer can then print the removable insert 304 via an additive manufacturing/3D printing technique or process at home or at a local 3D printing center.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A wiper blade comprising:
a frame structure;
a squeegee having a wiping lip; and
a plurality of branches extending between the frame structure and the squeegee.

2. The wiper blade of claim 1, wherein the plurality of branches is configured to manage compression and tension loads between the frame structure and the squeegee.

3. The wiper blade of claim 1, wherein the plurality of branches vary in thickness to conform the wiping lip to a windshield.

4. The wiper blade of claim 1, wherein the plurality of branches comprises a plurality of inter-connected members coupled between the frame structure and the squeegee and one or more cross-connected member coupled between two or more adjacent inter-connected members.

5. The wiper blade of claim 1, wherein, in an unloaded condition, the frame structure is curved and the squeegee is linear.

6. The wiper blade of claim 1, wherein the frame structure and the squeegee are an integrated component.

7. The wiper blade of claim 1, wherein the frame structure, the squeegee, and the plurality of branches is an integrated component.

8. The wiper blade of claim 1, wherein the plurality of branches is fabricated via an additive manufacturing technique.

9. The wiper blade of claim 1, wherein the plurality of branches is fabricated using one or more of thermoplastic polyurethane (TPU), thermoplastic vulcanizates (TPV), thermoplastic elastomers (TPE), and silicon.

10. The wiper blade of claim 1, wherein the plurality of branches is configured as a removable insert.

11. The wiper blade of claim 1, wherein the plurality of branches is arranged to form a truss structure.

12. The wiper blade of claim 1, wherein the plurality of branches is arranged to form a bird's nest.

13. The wiper blade of claim 1, wherein the plurality of branches is arranged to form a woven pattern.

14. A wiper blade comprising:
a frame structure;
a squeegee having a wiping lip; and
a plurality of branches extending between the frame structure and the squeegee,
wherein the plurality of branches is configured to manage compression and tension loads between the frame structure and the squeegee.

15. The wiper blade of claim 14, wherein the plurality of branches vary in thickness to conform the wiping lip to a windshield.

16. The wiper blade of claim 14, wherein the plurality of branches comprises a plurality of inter-connected members coupled between the frame structure and the squeegee and one or more cross-connected member coupled between two or more adjacent inter-connected members.

17. The wiper blade of claim 14, wherein, in an unloaded condition, the frame structure is curved and the squeegee is linear.

18. The wiper blade of claim 14, wherein the frame structure, the squeegee, and the plurality of branches is an integrated component.

19. A wiper blade comprising:
a frame structure;
a squeegee having a wiping lip; and
a plurality of branches extending between the frame structure and the squeegee,
wherein the plurality of branches is configured to manage compression and tension loads between the frame structure and the squeegee, and
wherein the plurality of branches comprises a plurality of inter-connected members coupled between the frame structure and the squeegee and one or more cross-connected member coupled between two or more adjacent inter-connected members.

20. The wiper blade of claim 19, wherein the plurality of branches is fabricated using one or more of thermoplastic polyurethane (TPU), thermoplastic vulcanizates (TPV), thermoplastic elastomers (TPE), and silicon.
